(19) United States
(12) Patent Application Publication
(10) Pub. No.: US 2005/0231475 A1
(43) Pub. Date: Oct. 20, 2005

(54) Combined joy pad and joystick controller

(75) Inventors: Ho Kee Herbert Law, Santa Clara, CA (US); Sheng Dong, Fremont, CA (US); Amal Prabhu, Santa Clara, CA (US); Toshiki Kikuchi, Fremont, CA (US)

Correspondence Address: MAYER, FORTKORT & WILLIAMS, PC, 251 NORTH AVENUE WEST, 2ND FLOOR, WESTFIELD, NJ, 07090, US

(73) Assignees: Sony Corporation; Sony Electronics Inc.

(21) Appl. No.: 10/824,243

(22) Filed: Apr. 14, 2004

(51) Int. Cl. G09G 5/08

(52) U.S. Cl. 345/161

(57) ABSTRACT

An apparatus for interfacing with a user includes both a joystick and a joy pad. The joystick provides one type of input from the user to a computer program. Moreover, the joy pad is disposed in close proximity to the joystick and provides another type of input from the user to the computer program. The digital joy pad has one or more discrete inputs. The joystick extends upward vertically from a center of the joy pad. The joystick may include a circular top with a beveled edge. The joystick top has a radius that extends almost to a beginning of the one or more discrete inputs of the joy pad, whereby a user can move the joy stick and depress one input of the digital joy pad with a single digit. Thus, by placing the joystick and the joy pad in close proximity to each other, both can be activated by a single user's digit.

### FIELD OF INVENTION

The present invention relates generally to interface methods and apparatuses for enabling a user to interact with computer programs executing on computers, and more particularly to an interface method and apparatus for enabling a user to provide rapid interaction with a computer program, such as a video game, executing on a computer.

### BACKGROUND

Computer systems employ interface devices extensively in computer-controlled games, simulations, and other applications that are very popular with the mass market of home consumers. In a typical implementation, a computer system displays a visual environment to a user on a display device. Users can interact with the displayed environment by inputting commands or data from the interface device. Popular interface devices include joysticks, “joy pad” button controllers, mice, trackballs, styluses, tablets, pressure spheres, foot or hand pedals, or the like, that are connected to the computer system controlling the displayed environment. The computer updates the environment in response to the user's manipulation of a moved manipulandum, such as a joystick handle or mouse, and provides visual feedback to the user using the display screen.

Most game controllers (such as those used in the Sony Playstation™) have a separate joy pad and joystick. At times, this arrangement makes it inconvenient for a user to switch between the joy pad and the joystick, especially in situations where the same hand is used to activate both the joystick and the joy pad. User interaction with the game is thus limited to the ability of a user to quickly switch between the joystick control and the joy pad control.

The present invention is therefore directed to the problem of developing a method and apparatus for enabling a user to quickly and easily provide input to a computer program to that the user can react more quickly to computer program stimuli.

### SUMMARY OF INVENTION

The present invention solves these and other problems by providing a user interface device or controller that includes a first manipulandum in combination with a second manipulandum. The first manipulandum provides a first type of input, for example, directional input parallel to a plane of a base of the controller, whereas the second manipulandum provides a second type of input, for example, directional input perpendicular to the base of the controller. This combination enables software programs to assign different operation and responses to the first and second manipulandi, thereby providing a more user desirable experience.

Thus, according to one aspect of the present invention, an exemplary embodiment of an apparatus includes a combined joy pad and joystick in close proximity, thereby enabling the user to employ either the joystick or the joy pad or both without switching or significantly moving his or her hands.

These and other advantages of the present invention will become apparent to those skilled in the art upon a reading of the following specification of the invention and a study of the several figures of the drawing.

### BRIEF DESCRIPTION OF THE DRAWINGS

FIG. 1 depicts a top view of an exemplary embodiment of a first manipulandum (such as a joystick) and a second manipulandum (such as a joy pad) according to one aspect of the present invention.

FIG. 2 depicts a front view of the exemplary embodiment of FIG. 1.

FIG. 3 depicts a front view of the exemplary embodiment of FIG. 1, in which the joystick is moved left.

FIG. 4 depicts a front view of the exemplary embodiment of FIG. 1, in which the left joy pad input is depressed.

FIG. 5 depicts a front view of the exemplary embodiment of FIG. 1, in which the left joy pad input is depressed in combination with the joystick being moved left.

FIG. 6 depicts a front view of another exemplary embodiment of a combination joystick and joy pad according to another aspect of the present invention.

FIG. 7 depicts the front view of FIG. 6 in which the joy pad and joystick are both moved left.

FIG. 8 depicts the front view of FIG. 6 in which the joy pad and joystick are both moved right.

FIG. 9 depicts a prior art implementation of controller that includes a joy pad.

FIG. 10 depicts an exemplary embodiment of a method for interfacing a user with a computer program executing on a computer according to another aspect of the present invention.

FIGS. 11-15 depict various exemplary embodiments of joystick and joy pad combinations according to still other aspects of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Skilled artisans will understand that a joystick is a part that extends from a supporting base which, in response to pressure (e.g., from a user's finger) from various directions normal to the major axis of the extending part, provides various electronic control outputs that are associated with the direction of the pressure. In some instances the joystick moves in response to the pressure. In other instances, the joystick remains essentially stationary and is pressure sensitive. In some instances, the joystick can be vertically depressed or even pulled (i.e., in a direction parallel to the major axis). The “stick” part of a joystick may incorporate other controls such as pushbutton switches or continuously variable level controls.

Similarly, skilled artisans will understand that a joy pad is an essentially planar arrangement which, in response to pressure (e.g., from a user's finger) normal to the plane at various positions on the pad, provides various electronic control outputs that are associated with the pad position that receives the pressure. In some instances the joy pad moves in response to the pressure. In other instances the joy pad remains essentially stationary and is pressure sensitive. In some instances a joy pad may appear as a short joystick having a broad, planar top, but the term joy pad should not be so narrowly construed.

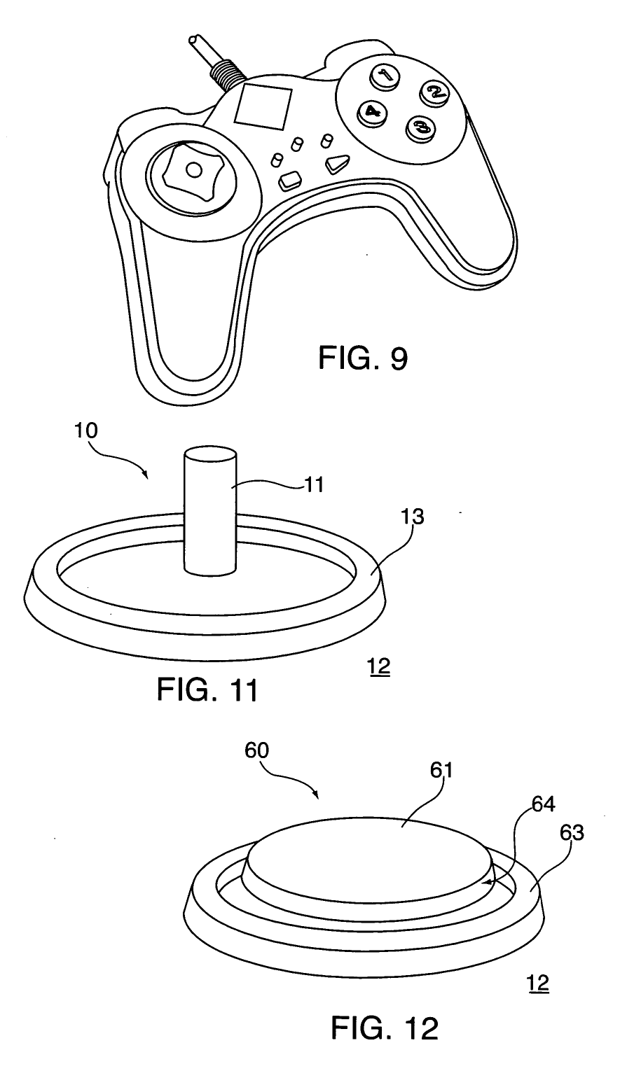

FIG. 9 shows a standard game controller that includes either multiple buttons (as on the right side) or a pad (as on the left side) that has multiple places that when depressed activates certain operations on a display. The left thumb control of the control device shown in FIG. 9 is illustrative of a joy pad, however, joy pads have applications in many other devices other than toy controllers.

In some instances joysticks and joy pads output discrete (digital) electronic control outputs (e.g., from on/off or multiple level push switches positioned at compass points around the joystick's axis or joy pad's center point). In some instances joysticks and joy pads output continuous (analog) control outputs (e.g., from variable resistance transducers positioned around the joystick or under the joy pad). Such discrete and/or continuous outputs are received as control inputs by various electronic devices (e.g., consumer electronic devices such as game consoles, personal digital assistants, personal computers, cellular telephones, cameras, control boxes, and the like). In some instances joysticks and joy pads simultaneously generate control outputs from two or more associated switches or sensors, such as from activation in a Northeast direction when such switches or sensors are positioned at the North and East of the joystick or joy pad.

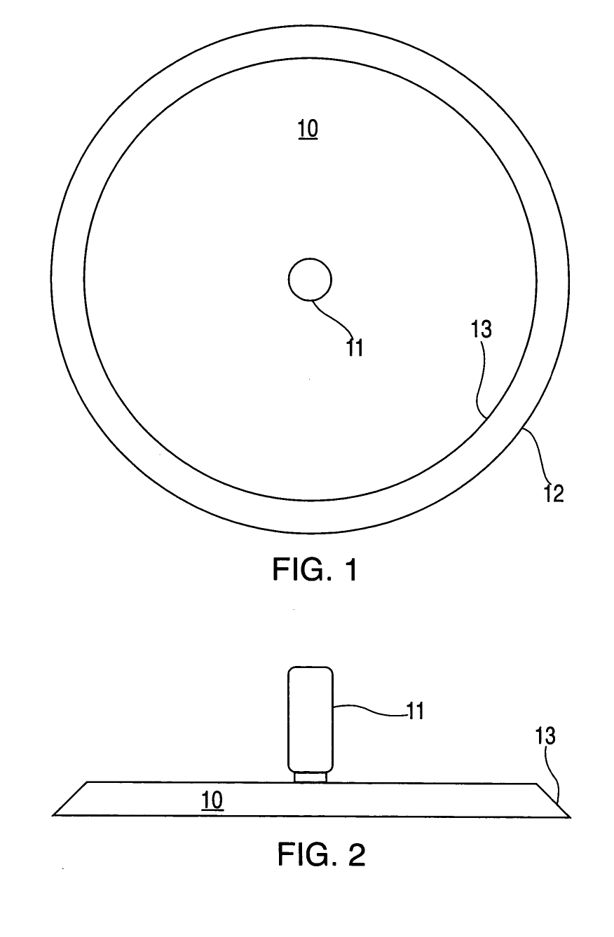

Turning to FIG. 1, shown therein is a top view of an exemplary embodiment of an apparatus for interfacing with a user for use with a computer program, such as a computer video game or the like. The apparatus 10 includes a joystick 11 extending vertically upwards from a base 12, on which is mounted a joy pad 13. The joy pad 13 includes one or more discrete inputs that when depressed cause predetermined operations on the display to which the computer is connected. This operation is shown in more detail in subsequent figures. The mechanical mounting apparatus and electronic control output structure of the joystick and the joy pad are typical of those employed in the prior art, and so they need not be described herein. The present invention provides that the joystick and the joy pad be placed in close proximity to each other so that a single digit of a user can manipulate or activate both simultaneously (see FIGS. 7 and 8). In the embodiment herein 10, the joy pad is shown as a ring having functions (e.g., up, left, right, down) assigned to various positions (top, left, right, bottom, respectively) on the ring. The joy pad can be a multifunction switch. Other types of multifunction switches are employed in other embodiments.

As shown in FIG. 2, which is a front view of the exemplary embodiment 10 of FIG. 1, the first manipulandum (e.g., a joystick) is disposed in a center (or nearly so) of the second manipulandum (e.g., a joy pad). In other embodiments, the first manipulandum is positioned at other locations, such as immediately to one side or the other or offset from the center of the second manipulandum, without departing from the scope of the present invention. The important point is that the first and second manipulandi be located in such proximity that one can manipulate either with a single digit if desired.

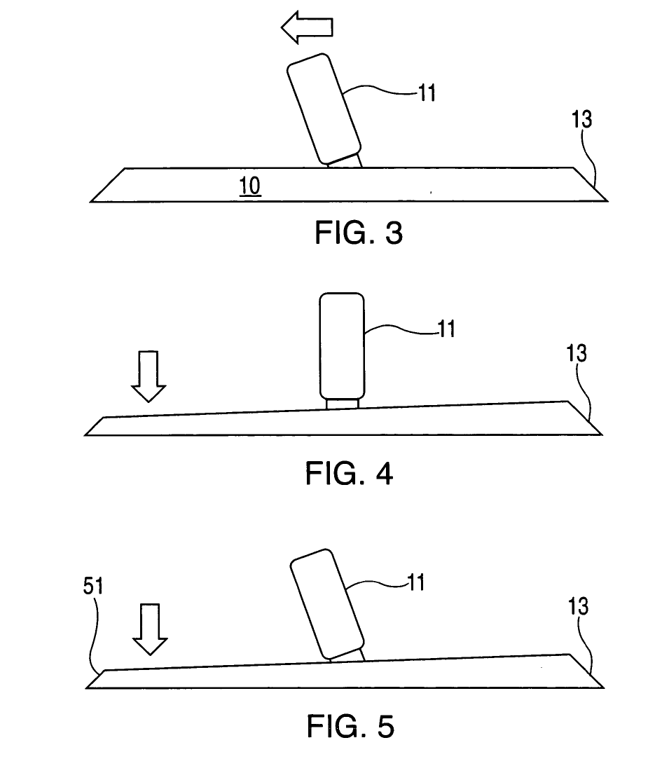

Turning to FIG. 3, moving the joystick 11 left will provide certain input to the computer program, such as to move a curser or other graphic left. Thus, the joystick can be manipulated in the normal manner without depressing the keys on the joy pad.

As shown in FIG. 4, depressing the joy pad 13 in the left area will also provide certain input to the computer program, such as a command to run left or to shoot left. As with the joystick, the joy pad can be depressed without activating or manipulating the joystick.

As shown in FIG. 5, depressing the joy pad 13 in the left area 51 in combination while moving the joystick left will also provide certain input to the computer program, such as simultaneous commands to turn left (e.g., from the joystick) and to shoot to the left (e.g., from the joy pad), or some other predetermined activity. Similar operations will occur by moving the joystick 11 right, up or down alone or in combination with depressing the joy pad in the right, up or down areas. Thus, the present invention makes possible combinations of inputs that are not possible in existing implementations without requiring the user to employ multiple fingers or hands. While left joystick and left joy pad inputs are shown, clearly all other combinations are possible.

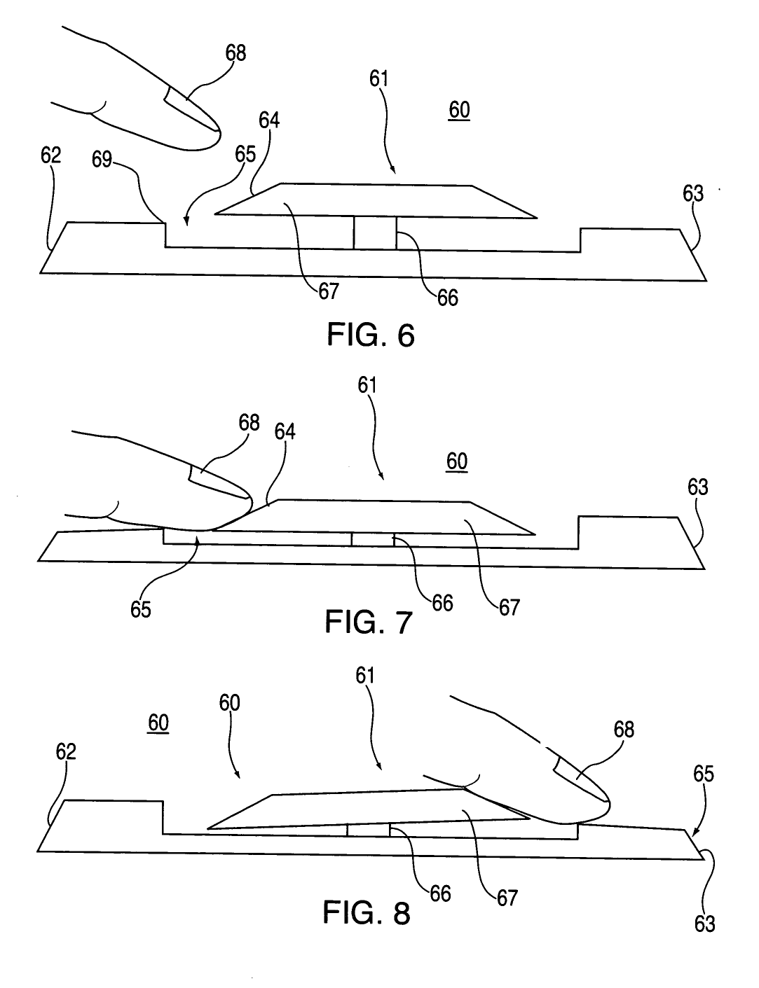

Turning to FIG. 6, shown therein is another exemplary embodiment 60 of a combined joystick 61 and joy pad 63. In this embodiment 60, the joystick 61 includes a circular top 67 with a beveled edge 64 so that a user can easily with a single digit 68 (e.g., a thumb or finger) depress the digital joy pad 63 and move the analog joystick 61. In this embodiment 60, the radius of the top 67 of the joystick 61 extends almost to the edge 69 of the joy pad 63 so that placing some pressure on one edge 64 of the joystick 61 allows the joystick 61 to pivot in one direction while enabling a single digit 68 of the user's hand to manipulate both the joystick 61 and a button 62 on the joy pad 63. The spacing 65 between the edge 64 of the joystick knob or top 67 can be modified depending on the size of the thumb or finger 68 for which it is designed and the length of the shaft 66 supporting the knob 67 or top of the joystick 61.

For example, as shown in FIG. 7, the user's thumb 68 depresses the left area 62 of the joy pad 63 while also moving the joystick 61 left by depressing the left edge 64 of the top or knob 67 of the joystick 61. Note that the spacing 65 is smaller than the width of the thumb 68 so that both the joystick 61 and the joy pad 63 can be activated simultaneously with a single digit 68.

Similarly, as shown in FIG. 8, the user can do the same thing on the right side 65 of the embodiment 60. The same is true for up and down or any angle around the joy pad.

According to one aspect of the present invention, the joystick and the joy pad are disposed in close proximity to each other. For example, the joystick can extend vertically up from the center of the joy pad. In this case, the joy pad can be any number of implementations, including but not limited to cross-shaped (up-down-left-right), star shaped (buttons at every 45 degrees) or circular shaped, in which case the joy pad could even have a continuous range of inputs around a circle (e.g., an analog input). In the latter case, depressing the ring at a certain spot would provide input related to the analog angular value on a circle detected by the input device.

In an alternative embodiment, the joystick and the joy pad could be placed next to each other so a single user's digit could reach both.

FIGS. 11-15 are perspective views of various joystick and joy pad combination embodiments. FIG. 11 is a front perspective view of the embodiment described in association with FIGS. 1-5.

FIG. 12 is a front perspective view of the embodiment described in association with FIGS. 6-8. In this embodiment, the “joystick” 61 appears to be a “joy pad” in that the top of the joystick 61 is a curved or flat surface that appears like a pad. The outer ring of the embodiment 60 is a joy pad. In essence, though, a joystick receives directional input normal to an axis of the “rod” or stick (or parallel to a plane of the base on which the controller is mounted), whereas a joy pad receives directional input perpendicular to the plane of the base on which the joy pad is mounted. Thus, an apparatus is disclosed in which two orthogonal control inputs can be applied with a single digit.

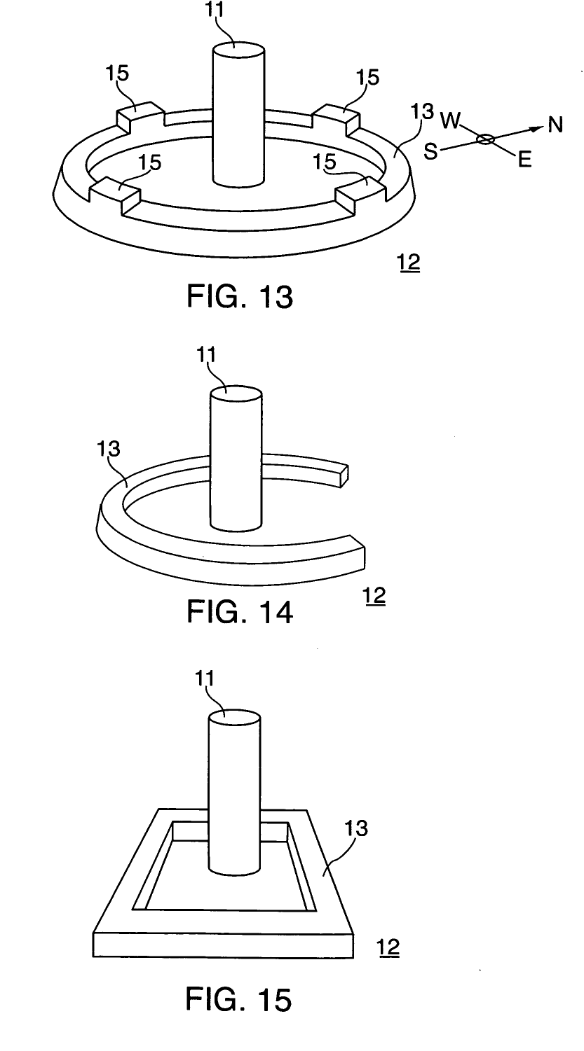

FIG. 13 is a right front perspective view of an embodiment, in which illustrative raised portions 15 are positioned on joy pad ring 13. The raised portions 15 are oriented in accordance with the four major points of a compass rose centered on joy pad ring 13, each raised portion 15 being also positioned over an underlying sensor (e.g., switch, pressure sensor; not shown) in base 12. The raised portions 15 assist a user to tactilely identify the correct control press to make on joy pad ring 13. FIG. 14 is a front perspective view illustrative of embodiments in which joy pad 13 does not completely surround joystick 11. FIG. 15 is a front perspective view illustrative of various geometric shapes (a square is shown) possible for joy pad 13.

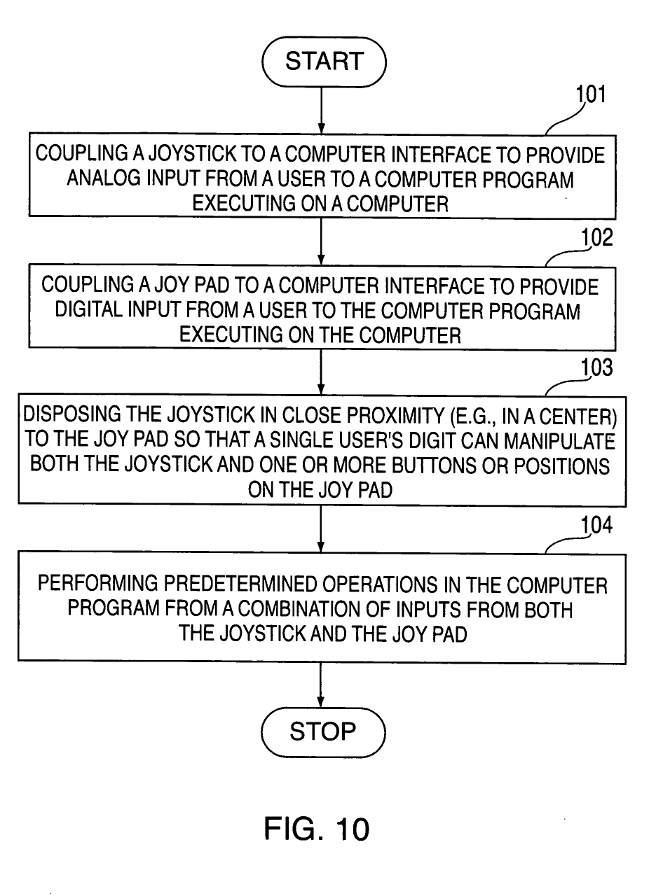

Turning to FIG. 10, shown therein is a method for interfacing a user and a computer program. This method provides a rich user experience for a video game, for example.

In element 101, a joystick is coupled to a computer interface to provide continuous (or analog) input from a user to a computer program executing on a computer. This continuous or analog input can be interpreted by the computer program in many ways, such as directional input for a video game. The joystick may include a knob disposed on a top of the joystick, in which case the knob has a circular top extending in radius to an edge of the directional inputs. The top may even include a beveled edge.

In element 102, a joy pad is coupled to a computer interface to provide discrete or digital input from a user to the computer program executing on the computer. As with the continuous or analog input, this discrete or digital input can be interpreted by the computer program in many ways, such as initiating certain operations in video game. The joy pad may include a multiple directional inputs disposed in a variety of patterns, such as a cross pattern, a circular pattern, or a star pattern (when inputs at every 45 degrees are desired). Moreover, the joy pad could even provide continuous or analog input by being a touch pad disposed in a circular pattern or rectangular pattern.

In element 103, the joystick is disposed in close proximity to the joy pad so that a single user's digit can manipulate both the joystick and one or more buttons or positions on the joy pad. One possible location is the center of the digital joy pad. Many others are also possible, however, without departing from the present invention.

In element 104, predetermined operations are performed in the computer program from a combination of inputs from both the joystick and the joy pad. The present invention makes possible combined discrete and continuous inputs that can then be interpreted as complex instructions by the computer program thereby enabling complex maneuvers, for example, in a video game.

Although various embodiments are specifically illustrated and described herein, it will be appreciated that modifications and variations of the invention are covered by the above teachings and are within the purview of the appended claims without departing from the spirit and intended scope of the invention. For example, certain implementations of joy pads are discussed, however, others are also possible without departing from the scope of the present invention. Furthermore, this example should not be interpreted to limit the modifications and variations of the invention covered by the claims but is merely illustrative of one possible variation.

1. An apparatus for interfacing with a user comprising:
a first manipulandum to provide a first type of input from the user to a computer program; and
a second manipulandum disposed in close proximity to the first manipulandum to provide a second type of input from the user to the computer program.

2. The apparatus according to claim 1, wherein the first manipulandum comprises a joystick.

3. The apparatus according to claim 1, wherein the second manipulandum comprises a joy pad.

4. The apparatus according to claim 3, wherein the first manipulandum comprises a joystick.

5. The apparatus according to claim 1, wherein the first type of input comprises directional input parallel to a base plane and the second type of input comprises directional input perpendicular to the base plane.

6. The apparatus according to claim 1, wherein said first type of input comprises continuous input and said second type of input comprises discrete input.

7. The apparatus according to claim 3, wherein said joy pad includes one or more inputs.

8. The apparatus according to claim 4, wherein said joystick extends upward vertically from a center of the joy pad.

9. The apparatus according to claim 4, wherein said joystick includes a circular top.

10. The apparatus according to claim 9, wherein the joy pad includes one or more inputs, and the circular top has a radius that extends almost to a beginning of the one or more inputs of the joy pad, whereby a user can move the joy stick and depress one input of the joy pad with a single digit.

11. The apparatus according to claim 10, wherein the circular top includes a beveled edge.

12. An apparatus for interacting with a computer comprising:
a multifunction switch including a plurality of buttons to accept one or more discrete inputs from the user; and
a joystick input device disposed in close proximity to the multifunction switch to accept continuous input from the user.

13. The apparatus according to claim 12, wherein the joystick is disposed in a center of the multifunction switch.

14. The apparatus according to claim 12, wherein the multifunction switch includes a plurality of discrete inputs disposed in a cross pattern.

15. The apparatus according to claim 12, wherein the multifunction switch comprises a plurality of discrete inputs disposed in a circular pattern.

16. The apparatus according to claim 12, wherein the multifunction switch comprises a plurality of discrete inputs disposed in a star pattern.

17. The apparatus according to claim 12, wherein the joystick includes a knob disposed on a top of the joystick, said knob having a circular top and extending in radius to the plurality of discrete inputs.

18. A method for interfacing a user and a computer program comprising:
coupling a joystick to a computer interface to provide first input from a user to a computer program executing on a computer;
coupling a joy pad to a computer interface to provide second input from a user to the computer program executing on the computer; and
disposing the joystick in close proximity to the joy pad so that a single user's digit can manipulate both the joystick and one or more buttons or positions on the joy pad.

19. The method according to claim 18, further comprising:
performing predetermined operations in the computer program from a combination of inputs from both the joystick and the joy pad.

20. The method according to claim 18, wherein the joystick is disposed in a center of the joy pad.

21. The method according to claim 18, wherein the joy pad includes a plurality of inputs disposed in a cross pattern.

22. The method according to claim 18, wherein the joy pad comprises a plurality of inputs disposed in a circular pattern.

23. The method according to claim 18, wherein the joy pad comprises a plurality of inputs disposed in a star pattern.

24. The method according to claim 18, wherein the joystick includes a knob disposed on a top of the joystick, said knob having a circular top and extending in radius to the plurality of directional inputs.

25. The method according to claim 24, wherein the knob includes a beveled edge.

26. The method according to claim 18, wherein the joy pad includes a touch pad.

27. An electronic control device comprising:
a joystick; and
a joy pad positioned around the joy stick.
